(19) United States
(12) Patent Application Publication
(10) Pub. No.: US 2011/0142454 A1
(43) Pub. Date: Jun. 16, 2011

(54) OPTICAL TRANSMISSION AND RECEPTION CONTROL APPARATUS

(75) Inventors: Hyo Hoon PARK, Daejeon (KR); Tae Woo LEE, Daejeon (KR); Mu Hee CHO, Daejeon (KR); Jong Hun KIM, Daejeon (KR)

(73) Assignee: KAIST (Korea Advanced Institute of Science and Technology), Daejeon (KR)

(21) Appl. No.: 12/696,621

(22) Filed: Jan. 29, 2010

(30) Foreign Application Priority Data
Dec. 15, 2009 (KR) 10-2009-0124514

(51) Int. Cl. H04B 10/12; H04B 10/00

(52) U.S. Cl. 398/141; 398/158

(57) ABSTRACT

An optical transmission and reception control apparatus is provided. The present invention relates to an optical transmission and reception control apparatus for enabling smooth optical transmission and reception when a photo diode and/or a laser diode fail. The apparatus includes a plurality of laser diodes, a laser driver, a first switching unit, a plurality of photo diodes, an optical power amplifier, a second switching unit, an optical power detection module, and a control module.

### CROSS-REFERENCE TO RELATED APPLICATION

This application claims priority to and the benefit of Korean Patent Application No. 2009-0124514, filed on Dec. 15, 2009, the disclosure of which is incorporated herein by reference in its entirety.

### BACKGROUND

1. Field of the Invention

The present invention relates to an optical transmission and reception control apparatus, and more particularly, to an optical transmission and reception control apparatus for enabling smooth optical transmission and reception when a photo diode and/or a laser diode fail.

2. Discussion of Related Art

In general, an optical transmission and reception apparatus includes a light source, a light source driver, a light receiving device, an optical filter, and a preamplifier.

In the optical transmission and reception apparatus, a transmitting stage employs a laser diode (LD) for converting an electrical signal into an optical signal and transferring the optical signal. In this case, a separate driving circuit is necessary for driving the laser diode, which is modulated by high current. Thus, the laser diode and the driving circuit constitute the transmitting stage for electrical-to-optical signal conversion.

In the optical transmission and reception apparatus, a receiving stage employs a photo diode (PD) for converting the optical signal from the transmitting stage into an electrical signal. A preamplifier and a limiting amplifier are necessary for amplifying and restoring the minute electrical signal from the photo diode. Thus, the photo diode, the preamplifier, and the limiting amplifier constitute the receiving stage for optical-to-electrical signal conversion.

In a conventional optical transmission and reception module for data transfer between a chip and a chip or between a board and a board, a pair of a transmitting stage and a receiving stage separately performs data transmission and reception.

That is, the transmitting and receiving stages are required for one data line in order to transmit and receive one piece of data. Accordingly, a transmitter (Tx) and a receiver (Rx) at both ends of the data line are separately necessary.

FIG. 1 is a circuit diagram of a conventional optical transmission and reception apparatus.

Referring to FIG. 1, a conventional optical transmission and reception apparatus includes an optical transmission module 10, an optical reception module 20 and an optical transfer module 30.

The optical transmission module 10 includes a laser diode LD for converting an electrical signal into an optical signal, and a laser driver 11 for driving the laser diode LD according to input data.

The optical reception module 20 includes a photo diode PD, a resistor R, a preamplifier (trans-impedance amplifier) TIA connected in parallel with the resistor R, and a limiting amplifier 21.

The optical transfer module 30 is connected between the laser diode LD and the photo diode PD. For example, the optical transfer module 30 may include an optical fiber or an optical waveguide to transfer the optical signal.

Meanwhile, in the conventional optical transmission and reception apparatus having the above-described configuration, the laser diode LD or the photo diode PD may easily fail due to heat or other causes, such that a module itself is unusable and thus must be replaced.

In general, a current-optical output curve that is a property curve of the laser diode LD shows that as surrounding temperature rises, a threshold current Ith increases and a slope η of the curve decreases. FIGS. 2(a) and 2(b) are graphs illustrating a typical temperature property of the laser diode. The temperature in FIG. 2(a) is lower than that in FIG. 2(b). Reference numerals A and B indicate average powers of the laser diode LD, C and D indicate amplitudes of an output optical pulse, and E and F indicate threshold currents at T1 and T2, respectively. G and H indicate a bias current and a modulation current signal input to the laser diode LD, respectively.

Referring to FIGS. 2(a) and 2(b), as temperature rises, the curve slope decreases and thus an optical power level decreases. Accordingly, an extinction ratio P1/P0 defined as a ratio of optical powers corresponding to digital levels “1” and “0” is reduced, and transfer efficiency is degraded as the temperature rises. An extinction ratio of a transmission module for optical communication is defined to be 8 to 10 dB or greater according to an international telecommunication standard. It may be difficult to satisfy the standard in a specific temperature range due to a temperature property of the laser diode LD.

Also, in order for an optical reception apparatus to easily receive light, output powers P1 and P0 of the laser diode LD corresponding to levels “1” and “0” must be constant irrespective of a temperature change. Therefore, it is necessary to control the bias current and the modulation current of the laser diode LD in order to provide a constant extinction ratio and a constant optical output power in spite of the temperature change.

For this, in conventional technology, an optical transmission module 10′ as shown in FIG. 3 is adopted to adjust an optical power in a laser diode LD.

FIG. 3 is a circuit diagram of another conventional optical transmission and reception apparatus.

Referring to FIG. 3, the optical transmission and reception apparatus includes a monitor photo diode MPD located near the laser diode LD of the optical transmission module 10′, and a preamplifier TIA connected in parallel with a resistor R. The intensity of light from the laser diode LD is detected and resultant detection information is sent to a laser driver 11. Based on the detection information, the laser driver 11 adjusts the optical power in the laser diode LD.

However, even in this case, when the laser diode LD or the photo diode PD fails, a module itself is unusable.

### SUMMARY OF THE INVENTION

The present invention is directed to an optical transmission and reception control apparatus for enabling smooth optical transmission and reception even when a photo diode and/or laser diode fail.

According to an aspect of the present invention, there is provided an optical transmission and reception control apparatus including: a plurality of laser diodes connected in parallel with one another for converting an input electrical signal into an optical signal; a laser driver for outputting an electrical signal to drive each laser diode; a first switching unit connected between the laser driver and each laser diode for selectively connecting the laser diodes to the laser driver according to a first switching control signal; a plurality of photo diodes connected in parallel with one another for sensing the optical signal output from the laser diode, converting the optical signal into an electrical signal, and outputting the electrical signal; an optical power amplifier for amplifying the minute electrical signal output from each photo diode and outputting an optical power having a constant level; a second switching unit connected between the optical power amplifier and each photo diode for selectively connecting the photo diodes to the optical power amplifier according to a second switching control signal; an optical power detection module for detecting a value of the optical power output from the optical power amplifier; and a control module for comparing the optical power value detected by the optical power detection module with a previously set reference value and outputting the first and second switching control signals for operating the first and second switching units according to the result of the comparison.

Here, the apparatus may further include an optical transfer module connected between each laser diode and each photo diode for transferring the optical signal.

The optical transfer module may include an optical fiber or an optical waveguide.

The optical power amplifier may include a preamplifier connected in parallel with a resistor for first amplifying the minute electrical signal from the photo diode; and a limiting amplifier for receiving the first amplified electrical signal from the preamplifier and causing the electrical signal to have a voltage gain suitable for a data receiving operation.

When the optical power value detected by the optical power detection module is smaller than the previously set reference value, the control module may control the first and second switching units to switch from currently connected laser and photo diodes to other laser and photo diodes.

The previously set reference value may be a voltage value when the photo diode does not operate.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a circuit diagram of a conventional optical transmission and reception apparatus;

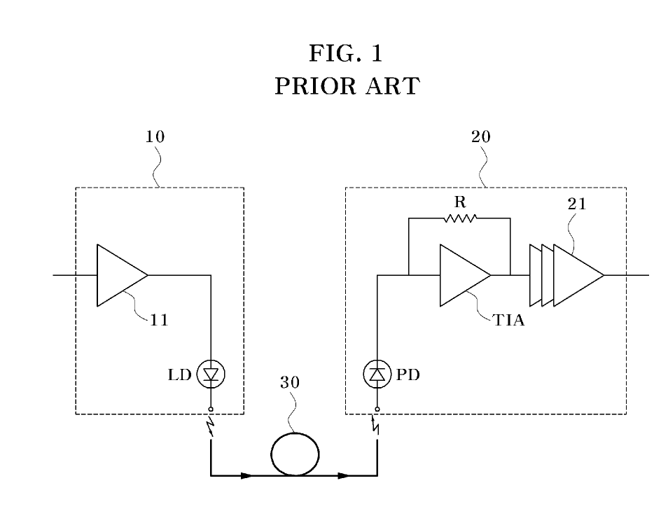

FIGS. 2(a) and 2(b) are graphs illustrating a general temperature property of a laser diode;

FIG. 3 is a circuit diagram of another conventional optical transmission and reception apparatus; and

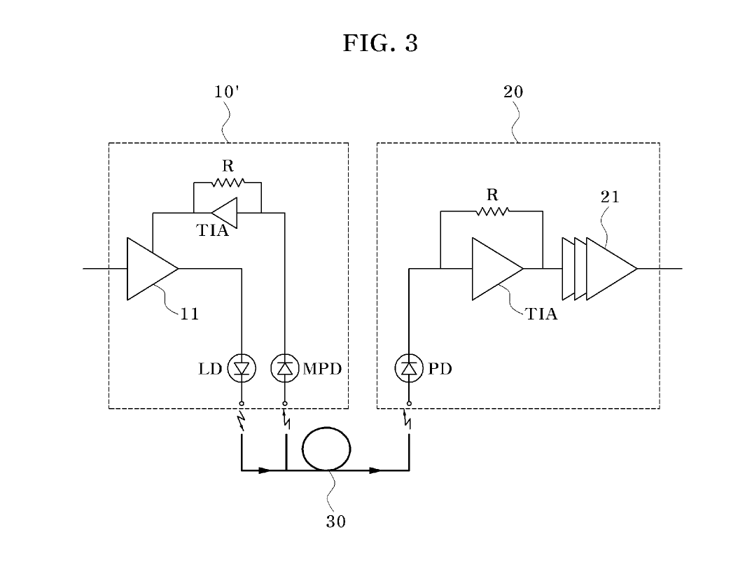

FIG. 4 is a circuit diagram of an optical transmission and reception control apparatus according to an exemplary embodiment to the present invention.

### DETAILED DESCRIPTION OF EXEMPLARY EMBODIMENTS

Exemplary embodiments of the present invention will be described in detail below with reference to the accompanying drawings. While the present invention is shown and described in connection with exemplary embodiments thereof, it will be apparent to those skilled in the art that various modifications can be made without departing from the spirit and scope of the invention.

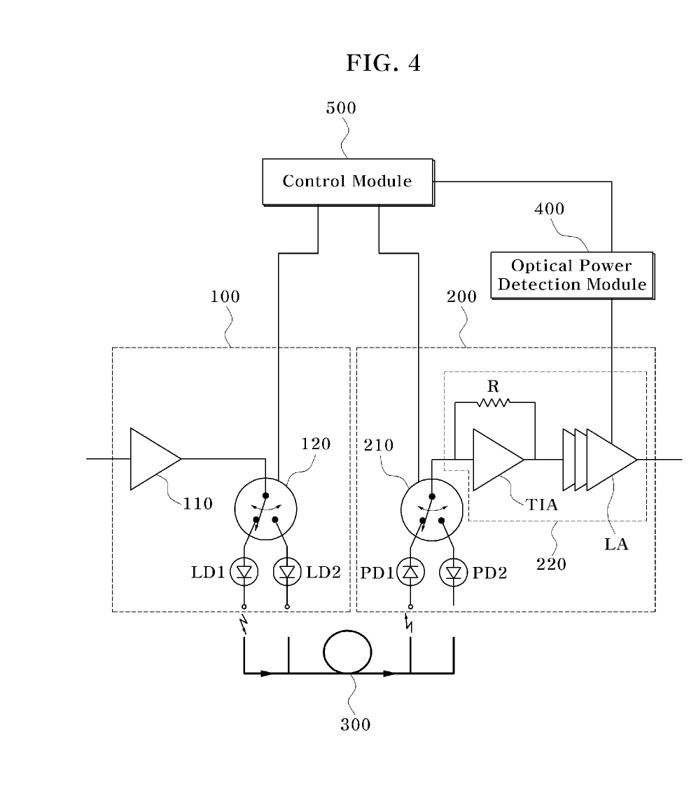

FIG. 4 is a circuit diagram of an optical transmission and reception control apparatus according to an exemplary embodiment to the present invention.

Referring to FIG. 4, the optical transmission and reception control apparatus according to an exemplary embodiment to the present invention includes an optical transmission module 100, an optical reception module 200, an optical transfer module 300, an optical power detection module 400, and a control module 500.

The optical transmission module 100 includes a plurality of laser diodes LD1 and LD2, a laser driver 110, and a first switching unit 120.

The plurality of laser diodes LD1 and LD2 are connected in parallel with one another for converting an input electrical signal (e.g., current) into an optical signal. Although the two laser diodes LD1 and LD2 are included for convenience of illustration in the exemplary embodiment of the present invention, the present invention is not limited thereto. More laser diodes may be included.

The laser driver 110 outputs an electrical signal (e.g., current) to drive the laser diodes LD1 and LD2 modulated by high current, such that the respective laser diodes LD1 and LD2 operate according to input data.

The first switching unit 120 is connected between the laser driver 110 and each of the laser diodes LD1 and LD2. The first switching unit 120 selectively connects the laser diodes LD1 and LD2 to the laser driver 110 according to a first switching control signal from the control module 500.

The optical reception module 200 includes a plurality of photo diodes PD1 and PD2, a second switching unit 210, and an optical output amplifier 220.

The plurality of photo diodes PD1 and PD2 are connected in parallel with one another for sensing the optical signal output from the respective laser diodes LD1 and LD2, converting the optical signal to an electrical signal (e.g., current), and outputting the electrical signal. That is, the photo diodes PD1 and PD2 sense the optical signal output in a pulse form from the laser diodes LD1 and LD2 and convert the optical signal into the current.

Although the two photo diodes PD1 and PD2 are included for convenience of illustration in the exemplary embodiment of the present invention, the present invention is not limited thereto. More photo diodes may be included to correspond to the laser diodes LD1 and LD2.

The second switching unit 210 is connected between the optical power amplifier 220 and each of the photo diodes PD1 and PD2. The second switching unit 210 selectively connects the photo diodes PD1 and PD2 to the optical power amplifier 220 according to a second switching control signal from the controller 500.

The optical output amplifier 220 includes a preamplifier (trans-impedance amplifier) TIA connected in parallel with a resistor R for first amplifying the minute electrical signal output from the photo diode PD1 or PD2, and a limiting amplifier LA for receiving the first amplified electrical signal from the preamplifier and causing the electrical signal to have a voltage gain suitable for a data receiving operation.

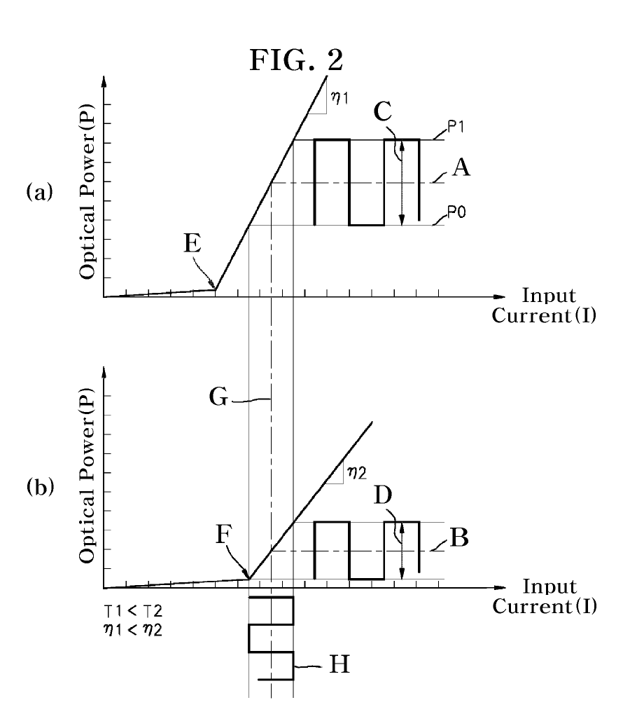

That is, the resistor R and the preamplifier TIA convert the current output from the photo diode PD1 or PD2 into a voltage. For example, when the photo diode PD1 or PD2 detects a current level corresponding to P0 of FIG. 2, the resistor R and the preamplifier TIA invert the current level and convert the resultant current level into a maximum voltage level.

The optical transfer module 300 is an optical signal transfer path between the laser diodes LD1 and LD2 and the photo diodes PD1 and PD2. For example, the optical transfer module 300 may include an optical fiber or an optical waveguide to transfer the optical signal.

The optical power detection module 400 is connected to an output terminal of the limiting amplifier LA in the optical power amplifier 220, and detects the optical power value (e.g., a voltage value) output from the limiting amplifier LA and delivers the optical power value to the control module 500.

The control module 500 compares the optical power value from the optical power detector 400 with a previously set reference value and outputs the first or second switching control signal to operate the first or second switching unit 120 or 210 according to the result of the comparison.

When the optical power value detected by the optical power detector 400 is smaller than the previously set reference value, the control module 500 controls the first and second switching units 120 and 210 to switch from the currently connected laser and photo diodes LD1 and PD1 to the other laser and photo diodes LD2 and PD2.

In this case, the previously set reference value may be a voltage value detected when the photo diodes PD1 and PD2 do not operate, and is used determine whether the photo diodes PD1 and PD2 operate. Even when the photo diodes PD1 and PD2 do not operate, a small amount of current flows, causing voltage generation.

If light is absorbed by the photo diodes PD1 and PD2 and optical current and thus a voltage signal are generated, the optical power value becomes greater than the previously set reference value. If the optical power value is smaller than the previously set reference value, this indicates that the photo diodes PD1 and PD2 do not operate. Accordingly, the control module 500 controls to switch from the currently connected laser and photo diodes to the other laser and photo diodes.

As described above, the optical transmission and reception control apparatus of the present invention enables smooth optical transmission and reception even when the photo diode and/or the laser diode fail.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. An optical transmission and reception control apparatus comprising:
a plurality of laser diodes connected in parallel with one another for converting an input electrical signal into an optical signal;
a laser driver for outputting an electrical signal to drive each laser diode;
a first switching unit connected between the laser driver and each laser diode for selectively connecting the laser diodes to the laser driver according to a first switching control signal;
a plurality of photo diodes connected in parallel with one another for sensing the optical signal output from the laser diode, converting the optical signal into an electrical signal, and outputting the electrical signal;
an optical power amplifier for amplifying the minute electrical signal output from each photo diode and outputting an optical power having a constant level;
a second switching unit connected between the optical power amplifier and each photo diode for selectively connecting the photo diodes to the optical power amplifier according to a second switching control signal;
an optical power detection module for detecting a value of the optical power output from the optical power amplifier; and
a control module for comparing the optical power value detected by the optical power detection module with a previously set reference value and outputting the first and second switching control signals for operating the first and second switching units according to the result of the comparison.

2. The apparatus of claim 1, further comprising an optical transfer module connected between each laser diode and each photo diode for transferring the optical signal.

3. The apparatus of claim 2, wherein the optical transfer module comprises an optical fiber or an optical waveguide.

4. The apparatus of claim 1, wherein the optical power amplifier comprises:
a preamplifier connected in parallel with a resistor for first amplifying the minute electrical signal from the photo diode; and
a limiting amplifier for receiving the first amplified electrical signal from the preamplifier and causing the electrical signal to have a voltage gain suitable for a data receiving operation.

5. The apparatus of claim 1, wherein when the optical power value detected by the optical power detection module is smaller than the previously set reference value, the control module controls the first and second switching units to switch from currently connected laser and photo diodes to other laser and photo diodes.

6. The apparatus of claim 1, wherein the previously set reference value is a voltage value when the photo diodes do not operate.
